(19) United States
(12) Patent Application Publication
(10) Pub. No.: US 2008/0147835 A1
(43) Pub. Date: Jun. 19, 2008

(54) PARTIALLY DECENTRALIZED COMPOSITION OF WEB SERVICES

(76) Inventors: Sunil Chandra, Bangalore (IN); Pankaj Kankar, New Delhi (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/612,859

(22) Filed: Dec. 19, 2006

(51) Int. Cl. G06F 15/16

(52) U.S. Cl. 709/223

(57) ABSTRACT

A partially decentralized composition of web services is performed by distributing the coordination responsibility of the component web services, originally performed at run time by the centralized execution language code, to multiple web service domains. The original software is divided into multiple code partitions and placed among different web service domains. These code partitions invoke one or more component web services and perform the required data transformation applicable to enable calling and returning data from the web services. The partitions may invoke more than one web service. The web service domains containing the code partitions that invoke more than one web services and perform the required data transformation become new coordinator nodes. In constrained data flow environments, to satisfy any data flow constraints, the data is sent from producer to consumer along a path restricted to the nodes eligible to access this data. The code performing the required data transformation is located on the nodes in this path and may span across multiple nodes.

### FIELD OF THE INVENTION

This invention relates to web services composition, particularly in a constrained data flow environment.

### BACKGROUND

Web services are self-contained, self-describing, modular applications that can be published, located and invoked across the Internet. They encapsulate information, software or other resources, and make them available over a network via standard interfaces and protocols. They typically are based on industry standard technologies of WSDL (to describe), UDDI (to advertise and syndicate) and SOAP (to communicate). Web services enable users to connect different components within and across organizational boundaries in a platform and language independent manner. New and complex applications can be created by aggregating the functionality provided by existing web services, referred to as service composition, and the aggregated web service is known as composite web service. The constituent web services involved in a service composition are known as component web services. Web service composition enables businesses to interact with each other and process and transfer data to realize complex operations. Furthermore, new business opportunities can be realized by utilizing the existing services provided by other businesses to create a composite service.

Composite web services may be developed using a specification language such as Business Process Execution Language for Web Services (BPEL4WS), or Web Services Choreography Interface (WSCI), or Business Process Modeling Language (BPML) and executed by an engine such as IBM's WebSphere™ Business Integration Process Choreographer, and IBM's Business Process Execution Language for Web Services Java Run Time (BPWS4J). Typically, a composite web service specification is executed by a single coordinator node. The coordinator node receives the client requests, makes the required data transformations and invokes the component web services according to the specification of composite service. This mode of execution is referred to as centralized orchestration. However, in certain scenarios businesses might want to impose restrictions on access to the data they provide or the source from which they can accept data. Centralized orchestration can lead to violation of these data constraints as the central coordinator has access to the output data of all the component web services and all the component web services receive data from central coordinator only.

Alternatively, fully decentralized orchestration might be used, where the original BPEL4WS is partitioned into as many partitions as the number of component web service and each partition resides with the component web service it invokes. The required data transformations are made by these partitions themselves. While a fully decentralized orchestration can overcome many data flow constraints, this approach has certain limitations. Not all the business providing web services may have engines to execute BPEL4WS process. Some of the businesses which have this capability may not allow BPEL4WS processes written by others to execute on their servers. Further, certain data flow constraints can not be met with any of the fully decentralized topologies possible. A fully decentralization approach is described in Chafle et al., “Orchestrating Composite Web Services Under Data Flow Constraints”, in proceedings of the 3^{rd} IEEE International Conference on Web Services, 2005.

Under common data flow constraints neither centralized nor fully decentralized orchestrations of composite web services are practicable. Therefore, the invention provides an improved method and system for composition of web services.

### SUMMARY

A partially decentralized composition of web services is performed by distributing the coordination responsibility of the component web services, performed at run time by the original centralized composite web service software, to multiple web services. The original software is divided into multiple code partitions and placed among different web services. These code partitions invoke one or more component web services and perform the required data transformation applicable to enable calling and the return of data from the web services. An advantage is that the partitions need not be co-located with the web service it invokes (as against fully decentralized composition) and a therefore the partition(s) may invoke more than one component web service. Also, data transformation is not restricted to domain(s) producing or consuming the data and can be performed by any web service that is eligible to access the data. The web services containing the code partitions that invoke more than one web services and perform the required data transformation are converted into new coordinator nodes. To satisfy any data flow constraints, the data is sent from producer to consumer along a path restricted to the nodes eligible to access this data. The code performing the required data transformation is located on the nodes in this path and may span across multiple nodes.

### DESCRIPTION OF THE DRAWINGS

FIG. 1 is a schematic block diagram of an example decentralization method.

FIG. 2 is a schematic block diagram of an example customer request servicing method

FIG. 3 is an example topology generated by an embodiment of the invention.

FIG. 4 is a schematic block diagram showing a runtime infrastructure.

FIG. 5 is a block flow diagram of implementing a constraint reinforcer.

FIG. 6 is a schematic block diagram of tools used to generate partitions.

FIG. 7 is a state diagram of a decentralizer.

### DETAILED DESCRIPTION

### Overview

In the known centralized orchestration approach discussed above, complete BPEL4WS flow resides at the coordinating node which executes it and coordinates the execution of all other component web services. In fully decentralized orchestration approach discussed above, there are no coordinating nodes, there are N number (N is number of component web services involved) of BPEL4WS partitions and all the BPEL4WS code partitions are co-located with the component web service they invoke.

In contrast, in an example embodiment of the present invention, multiple web service domains take up the run time responsibility of coordinating two or more component web services. In other words, the number of code partitions may vary between 1 to N (where N is number of component web services involved), and number of coordinating nodes may be zero or more.

Although BPEL4WS is presented as the preferred embodiment hereinafter, it is to be understood that the invention is not limited to any particular web service composition language, and applies to web services composition in general.

### Workflow

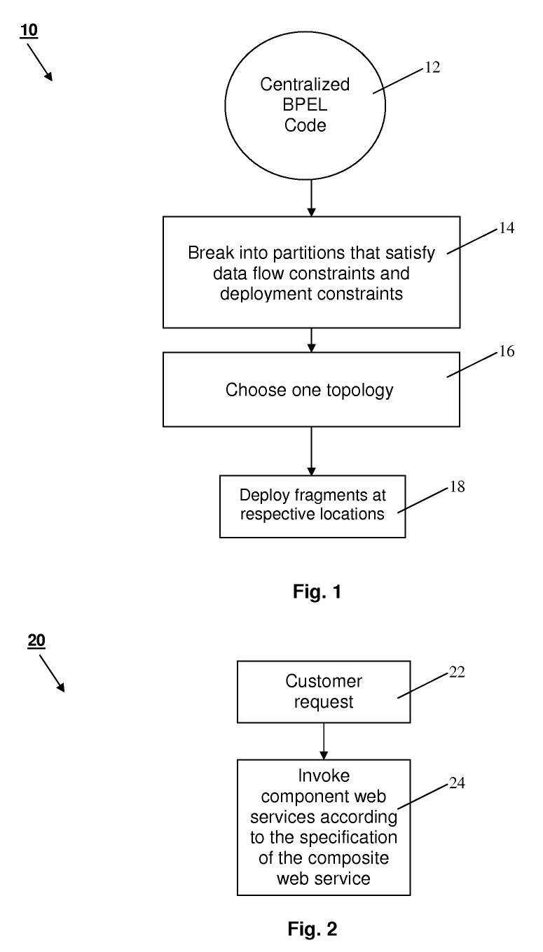

FIG. 1 shows a process flow 10, in which an original centralized BPEL4WS code 12 residing on a coordination node is broken into multiple BPEL4WS partitions in the step 14. Partitioning of the BPEL4WS code occurs at the time of service installation on a computing infrastructure or whenever associated overarching service composition policies change.

The partitioning generates a set of web services node topologies which meet predetermined data flow and deployment-related constraints, discussed below. The decentralization may lead to many topologies, involving a client interface node, one or more coordination nodes, one or more non-coordinator nodes (usually dependent upon a coordinator node), and one or more component web services. The component web services can depend directly on the receiving node, from a coordination node, or from a non-coordination node. A partition node (node containing BPEL4WS partition, it can be a coordination node or non-coordination node) operates to receive and transform input data (which can include the client request and data returned from a component web service that has already been executed). The partition node then calls any dependent component web services and receives the outputs form those web services. The partition node then transforms such received data and calls any dependent coordination or non-coordination nodes, else returns the results to a higher node in the topology.

In step 16, one of the topologies from the many topologies that are generated is chosen. If more than one topology is generated, then policies/constraints such as ‘topology leading to minimum response time’ or ‘topology having minimum number of hops’ can be used to choose one topology thereof. All partitions of the selected topology are then deployed at their respective system locations in step 18, resulting in a partially decentralized topology. The decentralization takes place at the time of service installation or whenever policies change.

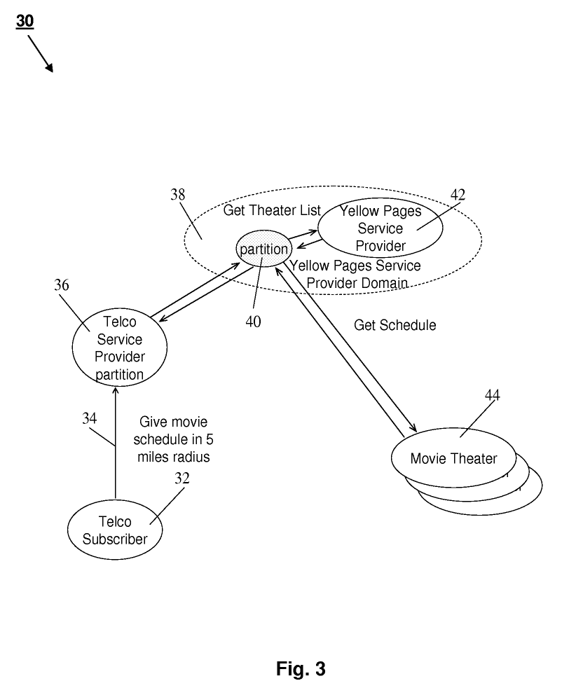

Referring now to the process flow 20 in FIG. 2, when a request 22, for example a customer request, is received by the composite web service, the request is executed by the partially decentralized topology generated by the process flow 10 of FIG. 1, where, in step 24, the component web services are invoked by their respective controlling coordination node according to the specification of the original composite web service. These coordination nodes may or may not be collocated with the component web services that they invoke.

### Web Services Example

Consider a Telecom Service Provider (telco) intending to provide a location-based service to the subscribers where subscribers can get a schedule of movies being screened at movie theaters in a radius of 5 miles from where the subscriber is located. There exists a Yellow Pages service provider incorporating web service that can provide a list of movie theaters and required contact information of the movie theatres in a radius of 5 miles from the subscriber's location. Also, the movie theaters deploy web services that provide movie schedules.

The telco develops a composite web service, that makes use of the web services provided by the Yellow Pages service provider and web services of the movie theaters, to provide a location based movie schedule service to subscribers. Without any data flow constraints, the telco can create composite web service(s) using centralized orchestration. The composite web service(s) deployed at the telco asks the Yellow Pages service provider to fetch a list of movie theaters located within a radius of 5 miles of the subscriber. The composite web service(s) requests all the movie theaters fetched by the Yellow Pages service for the movie schedules, and returns the consolidated schedule to the subscriber.

However, in a real world scenario, there may be constraints on data sharing. The example scenario discussed above has following data flow constraints:
1. The yellow pages service provider may not send the list of movie theaters to the telco. This is because telco may cache this information and once cached subsequently not access the yellow pages service provider for each invocation thus depriving the yellow pages service provider of repeated revenue.
2. The movie theaters may not send their schedule directly to the subscribers. Sending information directly to the subscribers requires that subscriber information is disclosed to the public, for example the movie theaters. Exposure of customer information is a sensitive privacy issue, and telcos may not be willing to disclose such sensitive information.

Besides the data flow constraints, the following deployment constraints of runtime infrastructure also exist.
3. Some movie theaters do not have infrastructure to execute BPEL4WS processes.
4. Some movie theatres, may have the capability to execute BPEL4WS processes, but may not allow BPEL4WS processes written by third parties to be executed on their servers.

With these constraints in place, centralized orchestration of the composite service is not possible as it violates constraint 1. Alternatively, a fully decentralized orchestration approach can be used to overcome such data flow constraints. In one such fully decentralized topology the yellow pages service provider calls the movie theaters on behalf of the telco and the movie theaters send their schedule directly to the telco. The issue with this topology is that the telco does not know how many movie theaters were contacted and thus how many responses the telco needs to wait for to complete the response for the request. Therefore, this is not a valid topology. In another possible fully decentralized topology, the movie theaters may send their schedule directly to the customer. This requires sensitive customer information related to the subscribers to be disclosed to the movie theaters which violates the data flow constraint 2 and hence prohibits the use of this topology.

Besides the data flow constraints discussed above, the fully decentralized topologies cannot meet the deployment constraints mentioned in items 3 and 4 above as any decentralized topology would require the movie theaters to run a partition of BPEL4WS process written by the telco.

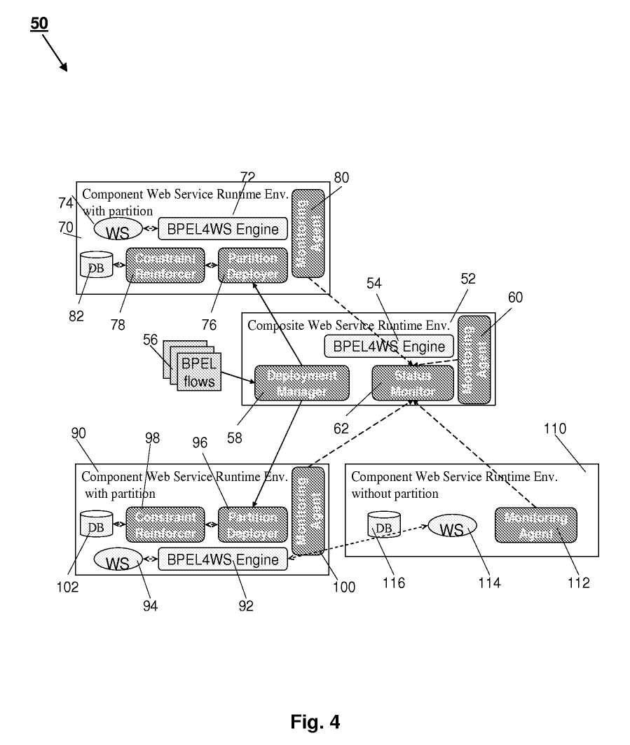

In one embodiment shown in FIG. 3, the BPEL4WS code is formed into two partitions 37, 40, taking into consideration the data flow constraints and deployment constraints, and the partitions are deployed over the web services topology 30 at two component services nodes: a Telco Service Provider's site 36 and a Yellow Pages Service Provider's Domain site 38. The Telco Service Provider's site 36 acts as a coordination node. The Yellow Pages Service provider's site 38 acts as a non-coordination node.

On receiving a request 34 from the client Telco subscriber 32 (i.e., a client node), the partition 37 within the Telco Service Provider's site 36 contacts the partition 40 (within the Domain site 38), which is configured to retrieve the list of movie theatres from a Yellow Pages web service 42. The list retrieved is used to contact the movie theatres 44, collate the results as a response, and returns the results to the partition 37. Thus, it becomes feasible for the partition 37 to compose the response for the web service request 34 even in the presence of the data flow and deployment constraints discussed above.

A partially decentralized orchestration system (such as the example system 30 of FIG. 3) consists of a runtime infrastructure and an optional set of automation tools.

### Runtime Infrastructure

FIG. 4 shows a representative architecture of a runtime infrastructure 50. This infrastructure 50 consists of: one composite web service runtime environment (node 52), at least one component web service runtime engine with partition (node 70, node 90), and zero or more component web service runtime engines without partition 110.

Composite Web Service Node: The node 52 is a client interface node. The BPEL4WS partition, residing in the BPEL4WS engine 54 at this node 52, is configured to receive any client requests (e.g., the block 24 in FIG. 2), and starts execution of the composite service. The node 52 also includes a deployment manager 58, a monitoring agent 60 and a status monitor 62, the function of which will be described below.

Component Web Service Node (with BPEL4WS partition): The nodes 70, 90 are component web service nodes with BPEL4WS partition (and thus examples of coordination nodes), which invoke the local web service, may also invoke web services in other domains (e.g., the web service of node 110) and may also perform the required data transformation. In terms of coordination responsibility, the component web service nodes with BPEL4WS partition can be further categorised as coordination nodes and non-coordination nodes. Node 90 invokes local web service as well as web services in other domains (web service of node 110), the node has to coordinate the invocation and execution of multiple web services and is thus termed as coordination node. Node 70 on the other hand invokes only the local web service, no coordination among multiple web services is involved and thus the node is termed as non-coordination node. The nodes 70, 90 include a partition deployer 76, 96, a constraint reinforcer 78, 98, a BPEL4WS Engine 72, 92, a monitoring agent 80, 100 and the component web service 74, 94. The data flow constraints are stored in the database (DB) 102.

Component Web Service Runtime Node (without BPEL4WS partition): The node 110 does not contain any BPEL4WS partition related to the composite web service (and thus an example of a non-coordination node). That is, it may be a node that does not have a BPEL4WS engine or it may not allow BPEL4WS partitions for this composite web service. The node 110 includes a monitoring agent 112 and the component web service 114. The data flow constraints are stored in the database (DB) 116.

The status monitor 62 receives status information (i.e., as shown by the dashed arrowheaded lines) from the monitoring agent 60 of its own node 52, and from the monitoring agents 80, 100, 112 of the other nodes 70, 90, 110.

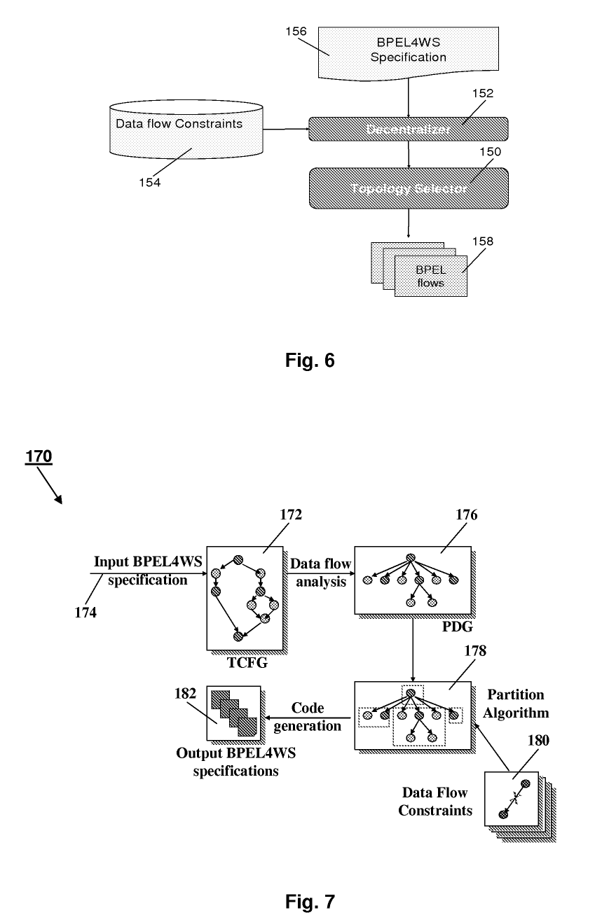

The deployment manager 58 receives the topology (i.e., a set of BPEL4WS flows, 56) selected for deployment from a topology selector 150 (shown in FIG. 6), and sends (i.e., shown by the solid arrowheaded lines) the partitions of that topology for deployment to the partition deployers 76, 96 of the corresponding component web service nodes 70, 90.

The partition deployer 76, 96 has two main functions: constraint checking and verification, and deployment. The partition deployer 76, 96 verifies that the BPEL4WS partitions are allowed to be deployed at the respective node 70, 90, and the partitions are allowed from this composite web service runtime environment 52 and authenticity of the composite web service runtime environment 52. The partition deployer 76, 96 further verifies whether the partition submitted for deployment at the respective node 70, 90 satisfies all applicable data flow constraints. Constraint checking and verification is essential because the partition is generated by an external entity and after deployment the partition executes within the domain as a trusted piece of code and has full access to unencrypted output data of the component web service if encryption is being used.

The partition deployer 76, 96 accepts the incoming BPEL4WS partition form the deployment manager 58 and passes the partition to the constraint reinforcer 78, 98 to generate the additional set of constraints. In cases where encryption is being utilized, the constraint reinforcer 78, 98 will also be utilized to add additional security policies to the existing security policies so that any confidential data that is flowing out of that node in the form of newly created message types is also encrypted. The partition is then passed through a constraint checker (not shown, but a part of the partition deployer 76, 96) that checks that the partition adheres to all the data flow constraints. After constraint checking and verification, the partition is then deployed on to the BPEL4WS engine 72, 92.

The goal of the constraint reinforcer 78, 98 is to ensure that the data flow constraints are applied to any new message types that are generated as a result of data transformations being applied to a message type that was part of the original constraints. This new set of constraints will be similar to the ones that already exist for the original message type differing only in the name of the message type and message fields.

The constraint reinforcer 78, 98 uses the Data Dependence Graph (DDG) to trace the transformation of the output data of the component web service. For each partition, the constraint reinforcer 78, 98 searches for all invokes/replies in that partition. For each invoke/reply the constraint enforcer 78, 98 extracts the input message type. The constraint reinforcer 78, 98 uses the DDG to trace back to the origin of this input message type. The constraint reinforcer 78, 98 then searches for all the constraints in the constraints database 82, 102 that have this original message type as part of the tuple (see below). For all such constraints, the constrain enforcer 78, 98 generates a new set of constraints essentially similar to the original ones but with the original message type and message field names replaced by the newly generated message type and message field names.

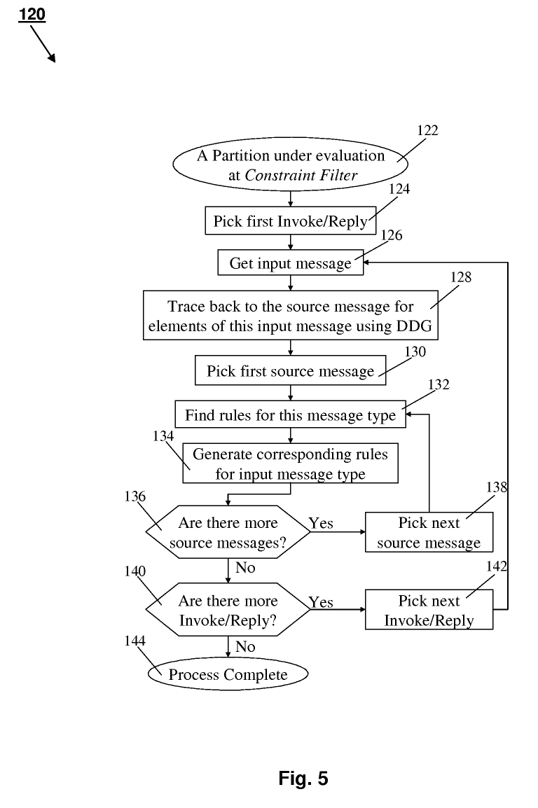

FIG. 5 is a flow diagram showing an algorithm 120 implementing the constraint reinforcer 78, 98 as a flow diagram. The process flow begins at step 122 with a partition under evaluation at the constraint reinforcer 78, 98. At step 124, the first invoke/reply is picked. At step 126, the input message is identified. At step 128, a DDG is used to trace back to the source message for elements of this input message. The first source message is picked at step 130. The rules for this message type are found at step 132. At step 134, the rules corresponding for the input message type are generated based on rules found at step 132. These rules are essentially similar to rules found at step 132, but the message type and message field names are corresponding to the input message. At this point, at step 136, it is determined whether there are any further source messages. If yes, then at step 138, the next source message is picked and the process is repeated from step 132. If no, then at step 140 it is determined whether there are any more invoke/reply requests to be processed. If yes, then at step 142, the next invoke/reply request is picked and the process flow returns to step 126. If no, then in step 144 the process has completed.

Constraints are expressed as a 3-tuple of <source, destination, MessageType>. Both the source and the destination are expressed in terms of a domain name. MessageType is the input message type that a particular port type expects. Constraints fall under the “Allowed” and “Not Allowed” categories. “Allowed” constraints are those where either a source can send data to given set of destinations, or where a destination can accept data from the given set of sources. “Not allowed” constraints are those where either a source cannot send data to a given set of destinations or where a destination cannot receive data from given set of sources. The source and destinations can also be expressed in terms of domain name sets e.g. *.co.jp for all companies located in Japan.

In the movie theater example described above, the data flow constraints for the Yellow Pages Service Provider 42 can be expressed as follows:

```
<Allowed>
    <Source>X Yellow Pages</Source>
    <Destination>* Movie Theater</Destination>
    <MessageType>*</MessageType>
</Allowed>
<NotAllowed>
    <Source>X Yellow Pages</Source>
    <Destination>*</Destination>
    <MesssageType>MovieTheaterList</MessageType>
<NotAllowed>
```

The “Allowed” and “NotAllowed” constraints can appear in any relative order in the Rules schema with the condition that more specific constraints appear first followed by the less specific ones.

### Automation Tools

FIG. 6 shows tools used for automatically generating BPEL4WS partitions from centralized BPEL4WS code, namely a topology selector 150 and a decentralizer 152. The tools draw on the stored data flow constraints and deployment constraints 154 and the BPEL4WS specification 156. The BPEL4WS flows 158 generated by these tools 150, 152 are fed to the deployment manager 58 of runtime infrastructure 50.

Decentralizer: The decentralizer 152 partitions the composite web service specification using program analysis techniques taking data flow constraints and deployment related constraints into account. The partitions are composite web service specifications themselves that execute at distributed locations and can be invoked remotely. The decentralizer 152 also generates the WSDL descriptors for each of these partitions. The WSDL descriptors permit them to be deployed and invoked in the same way as any standard web service.

An algorithm to create decentralized topologies from a given composite BPEL4WS specification will now be described with reference to the state diagram 170 of FIG. 7. In FIG. 7 the boxes represent (intermediate) output and the arrowheaded lines represent procedural steps. All activities are divided into three categories—receive, pick and reply are classified as Fixed Nodes, invoke is classified as Partially Fixed Node and all the other activities are classified as Portable Nodes.

A Program Dependence Graph (PDG) based code partitioning algorithm designed for multiprocessor execution can be used to implement the state diagram 170. Such an algorithm creates independently schedulable tasks at the granularity of partitions of a PDG. To reduce overhead, such algorithms try to merge several PDG nodes to create a larger partition, possibly sacrificing parallelism.

A Threaded Control Flow Graph (TCFG) representation 172 of the composite web service is created. The data dependencies (not shown) are added to this TCFG 172 to get a first PDG 176. For BPEL4WS flows, special handling related to flow and sequence activities are performed. From the control dependence point of view, all the activities inside one leg of the flow activity are dependent on the flow activity, which is in turn dependent on its container activity (e.g., flow or sequence). All the legs of the flow activity have no control dependence among them except for the explicit link constructs. Further, flow activity does not have any data dependence, and the removal of this flow activity from the PDG 172 makes no difference to composition of web services. Similarly, the purpose of sequence activity is to provide a container for other activities and it does not have any real data or control dependency, and therefore all the sequence activities can also be removed from the PDG with out any loss of information. This PDG 176 is further modified to ensure that all the data dependent edges (other than loop-carried dependencies and across TCFG-level edges) are from the left to right direction. These modifications are done by reordering the activities. In this state, the PDG may have data dependent edges across various hierarchical levels of the PDG. These across TCFG-level edges are now broken into at most three different data dependence edges as follows:
1. Taking two nodes between which the across-level data dependent edge exists: node A and node B, and the edge is from node A to node B. Now, a common ancestor of the two nodes, a node C is found.
2. If the common ancestor happens to be one of the two nodes, the edge is not broken. 3. If the common ancestor happens to be immediate parent of any of the two nodes, the edge is broken into two edges. If node C is immediate parent of node A, then a node D is found such that node D is ancestor of node B and sibling of node A. Now, the node A→node B edge is broken into node A→node D and node D→node B edges. Similarly, if node C is immediate parent of node B, then node D is found such that it is ancestor of node A and sibling of node B.
4. In all the other cases, node D and node E which are immediate children of node C but ancestor of node A and node B respectively are found. Now, the node A→node B edge is broken into node A→node D, node D→node E and node E→node B edges.

A PDG-based code partitioning algorithm 178 first breaks the PDG 176 into independently executable program sections, which in this case are individual BPEL4WS activities, and then tries to merge them to create manageable number of partitions. Consequently, the problem of code partitioning in this case is actually merging individual activities together to create partitions, which are semantically similar to the input BPEL4WS specification 174.

For this purpose, starting at the bottom of the Program Dependence Tree, the sibling nodes that have the same control dependence condition are identified and those nodes are merged. Two sibling nodes in the PDG 176 that have the same control dependence relationship between them if the reversal of flow order of these two nodes does not violate any other dependency. Once all the nodes at one level are merged, this algorithm is applied recursively to the higher levels of the tree till the root node is reached. The result is the partitioned output BPEL4WS specification 182. An informal description of the algorithm is as follows:
1. Locate a control node, N_{c} in the PDG and all child nodes associated with the control node are leaf nodes. For all the nodes that have the same control dependence condition on N_{c} repeat steps 2 through 6. Continue the process till all the control nodes have been processed.
2. For the control node N_{c}, divide all its children into two sets P and F, where P consists of all the Portable Nodes and F consists of all the other nodes. For each node in P, chose a node in F and merge the portable node P with the node from F. If all the merging combinations are exhausted, go to step 9.
3. Move all the portable nodes next to the node with which they are to be merged and arrange them in a linear order such that all the data dependent edges among the nodes merged together are from the left to right direction. If no such ordering is feasible, discard the merging and go back to step 2.
4. Arrange all the groups (where one group consists of a node from F along with its merged nodes) such that all the data dependent edges among the groups are from the left to right direction. If no such ordering is feasible, discard the merging and go back to step 2.
5. Treat N_{c} as a leaf node.
6. Repeat step 1 to 5 for all the levels of the PDG, thereby creating one topology with partitions which are either groups of Fixed Nodes along with their merged nodes or groups of Partially Fixed Nodes which were merged with themselves in step 2 along with their merged nodes.
7. Merge all Partially Portable Nodes in F with their merged Portable Nodes with some node in F including itself. When a node is merged with itself this means it will be co-located with the web service it invokes.
8. The nodes which were merged with themselves in step 8 are given the constraints of the web services they invoke and the Fixed Nodes are given the constraints of the composite web service. It can be verified that the topology identified in step 2 to 7 does not violate any data flow constraint and deployment related constraints. If any of the constraints are violated, it is discarded, otherwise code for that topology is generated.
9. Steps 7 to 8 are repeated for all the possible mergers of nodes in P with nodes in F and all the Partially Portable Nodes in F.

Topology Selector: The topology selector 150 ranks the topologies generated by the decentralizer 152 according to some given criteria such as “minimum response time” or “maximum throughput” or “minimum data transfer”. The best topology as ranked by the topology selector 150 is chosen for deployment. The topology selector 150 receives all the topologies generated by the decentralizer 152 as its input. It also takes one or more appropriate criterion to rank the topologies.

We claim:

1. A method for executing a composite web service comprising:
receiving a web service request at a composite web services receiving node;
routing the web service request to a plurality of component web services nodes, wherein a said component web service node is either a coordination node or a non-coordination node; and
aggregating the partial responses to create a response to the web service request.

2. The method of claim 1, further comprising creating at least one partial response from said component web services nodes.

3. The method of claim 2, wherein creating at least one partial response includes invoking component web services from a coordination node to execute at least a part of the web service request to return the partial response.

4. The method of claim 2, wherein creating at least one partial response includes invoking one component web service from a non-coordination node to execute at least a part of web service request to return the partial response.

5. A method for composing a web service comprising:
creating said web service as a centralized software entity;
dividing web service software entity into executable code partitions; and
deploying said partitions to one or more component web services nodes.

6. The method of claim 5, wherein said dividing is performed according to a criterion that each partition transforms only that data to which it has access.

7. The method of claim 5, wherein said division is performed according to a criterion that each partition routes only that data to which it has access.

8. The method of claim 5, wherein said division is performed according to a criterion that the partition is deployed only by those component web service nodes which have capability to execute such partitions, and are accept to host such partitions.

9. The method of claim 5, further comprising:
choosing a topology of component web services nodes according to predefined criteria; and
deploying said partitions upon said web services nodes according to said chosen topology.

10. The method of claim 9, wherein a said criterion is that a topology having the least number of co-ordination nodes is chosen.

11. The method of claim 5, further comprising:
verifying by each component web service node, that the composite web service partition being deployed adheres to constraints specified by the said node.

12. A method for partitioning a web services execution language into partitions comprising:
representing a composite web service as a threaded control flow graph;
treating each activity as a separate node;
dividing activities variously into fixed nodes, partially fixed nodes and variable nodes;
treating partially fixed nodes as fixed node and merging variable nodes with fixed nodes;
merging partially fixed nodes with fixed nodes; and
filtering out those nodes of said graph that do not adhere to predetermined constraints.

13. A web services system comprising:
a composite web services receiving node configured to receive web service requests;
a plurality of component web services nodes configured to create at least one partial response, where a said component web service node is either a coordination node or a non-coordination node, and wherein a coordination node executes at least a part of a request invoking more than one component web services to return at least a partial response, and a non-coordination node executes at least a part of said request by invoking one component web service to return at least a partial response; and
an output node configured to return an aggregation of all of said responses thereby forming a response to said request.

14. The system of claim 13, wherein said output node coincides with said receiving node.

15. The system of claim 13, wherein the coordination node aggregates all partial responses received by it.

16. A web services system comprising:
at least one client node generating web services requests;
a composite web services node receiving said client node requests;
a plurality of component web services nodes;
one or more coordination web services nodes in communication with said receiving node and said component web services nodes, and having at least one partition of web service execution code, and invoking one or more component web services residing on one or more predetermined eligible web services servers in response to a said web services request; and
one or more non-coordination web services node in communication with said receiving node and said component web services nodes, and having one partition of web service execution code and invoking one component web service residing on predetermined eligible web services servers in response to a said web services request.

17. The system of claim 16, wherein one or more of said coordination nodes are collocated with respective said web services servers.

18. A system for executing a composite web service in a data flow and deployment constrained environment, said system including a deployment infrastructure for deploying the partitions of topology selected for deployment, said infrastructure comprising:
a deployment manager that contacts partition deployers of component web service nodes and submits partitions for deployment, and presents the credentials of the composite web service node for authentication;
a partition deployer per component web service node available to host composite web service partition, and wherein such deployer:
(i) accepts a composite web service partition from the deployment manager of the composite web service;
(ii) authenticates said composite web service;
(iii) verifies that said composite web service is permitted to submit a composite web service partition for hosting; and
(iv) verifies that a submitted composite web services partition satisfies constraints specified by a component web service node; and
a constraint reinforcer per component web service node available to host a composite web service partition, that generates a set of constraints based on the submitted composite web service partition and policies specified by a component web service node.
